(19) United States
(12) Patent Application Publication
(10) Pub. No.: US 2002/0017492 A1
(43) Pub. Date: Feb. 14, 2002

(54) Method of substantially continuously separating two compounds using a moving bed or a simulated moving bed

(75) Inventors: Thomas Birger Jensen, Delft (NL); Hugo Arthur Honore Billiet, Berkel/Rodenrijs (NL); Lucas Antonius Maria Van Der Wielen, Bleiswijk (NL)

Correspondence Address: DARBY & DARBY P.C., 805 Third Avenue, New York, NY, 10022, US

(73) Assignee: Alpharma AS and Technische Universiteit Delft

(21) Appl. No.: 09/872,469

(22) Filed: Jun. 1, 2001

Related U.S. Application Data
(63) Continuation of application No. PCT/NL99/00739, filed on Dec. 3, 1999.

(30) Foreign Application Priority Data
Dec. 4, 1998 (GB) 9826684.4

(51) Int. Cl. B01D 15/08

(52) U.S. Cl. 210/657

(57) ABSTRACT

The present invention relates to a method of separating a first solute A and a second solute B using (simulated) moving bed chromatography. According to the present invention at least one of a) a feed stream; and b) a desorbent stream comprises an organic solvent. The use of different solvent liquids for the feedstream and the desorbent stream results in an increased difference in partition coefficients for solute A and solute B. According to the present invention it is possible to obtain solute A in an extract stream in a form which is more concentrated in comparison to the concentration of solute A in the feedstream.

The present invention relates to a method of substantially continuously separating a first solute A and a second solute B which are present in a feed stream further comprising a first solvent liquid, using a moving-bed device which contains a sorbent material and comprises an inlet for the feedstream, an inlet for a desorbing second solvent liquid, an outlet for an extract stream comprising solute A, an outlet for a raffinate stream comprising solute B, and a further outlet, said method comprising

introducing the feed stream into the moving-bed device;

introducing the desorbing second solvent liquid into the moving-bed device in a relative countercurrent motion with respect to the sorbent material;

discharging the extract stream relatively enriched in solute A with respect to solute B; and

discharging the raffinate stream relatively enriched in solute B with respect to solute A;

the course between the inlet for second solvent liquid and the outlet for the extract stream defining a first zone 1;

the course between the outlet for the extract stream and the feed stream inlet defining a second zone 2;

the course between the feed stream inlet and the outlet for the raffinate stream defining a third zone 3; and

the course between the outlet for the raffinate stream and the further outlet defining a fourth zone 4;

wherein in each of the zones k, k being 1-4, mₖ is defined as the ratio of a) the liquid flow in zone k; and b) the sorbent flow in zone k,

wherein at least one of i) the desorbing second solvent liquid; and ii) the first solvent liquid comprises an organic solvent, each solvent liquid comprising a set consisting of at least one essentially pure solvent compound, whereby the sets of the solvent liquids are selected to differ in their capability to remove an adsorbed compound from the sorbent material, the first solvent liquid and the desorbing second solvent liquid being completely miscible with each other; and

K_{Aextract} is defined as the partition coefficient of solute A in the solvent liquid of the extract stream;

K_{Bextract} is defined as the partition coefficient of solute B in the solvent liquid of the extract stream;

K_{Araffinate} is defined as the partition coefficient of solute A in the solvent liquid of the raffinate stream;

K_{Braffinate} is defined as the partition coefficient of solute B in the solvent liquid of the raffinate stream, and m2 and m3 are chosen such that

i) m2<m3

ii) K_{Bextract}<m2

iii) m3<K_{Araffinate*}

Such a method is generally known in the art of simulated moving bed (SMB) separation of solutes present in a solvent. More in particular, U.S. Pat. No. 4,461,649 (1984) describes a method of extracting a compound (sucrose) from a feed stream (molasses) using SMB. A desorbent liquid, comprising an organic compound (ethanol), was used to desorb sucrose from a sorbent material in the bed. The sucrose is present in a product extract stream at a concentration lower than the concentration of sucrose in the feed stream.

The present invention is directed at improving the method according to the preamble, and in particular to provide a method which results in an extract stream comprising the product in a higher concentration than in the feed stream. In addition it is desired to provide a method with reduced consumption of desorbent liquid. Further goals will be clear from the following description.

The method according to the present invention is characterized in that

iv) m2<K_{Aextract}; and m2 and m3 are chosen such that for a particular m2

v) m3>K_{Braffinate} and m3>K_{Aexract*}

Surprisingly, it has been found that it is possible to obtain a product stream in which the product is more concentrated than in the feed stream. Given the fact that, due to the addition of a desorbent stream, the total amount of liquid increases this is surprising indeed. In the present application, the term “solute” refers to a compound which is, under the same conditions (in particular at the same temperature) as during the process but in the absence of the first solvent liquid, a solid. The use of different solvent liquids for the feedstream and the desorbent stream—from which an increased difference between the partition coefficients and thus a difference in their capability to solubilize at least one of the solutes A and B due to the different hydrophilic/hydrophobic nature of the solvent liquids ensues—makes it possible to achieve a considerable saving in organic solvent. In general, a solvent liquid comprising the organic solvent will comprise at least 1% by vol. of the organic solvent, more usually at least 5% by vol. Thus it is possible to provide for aqueous solvent liquids differing significantly in their effect on the partition coefficients and/or hydrophilic/hydrophobic nature and thus their capability to dissolve the solutes A and B. Of course, any of the solvent liquids may comprise up to 100% by vol. of organic solvent and it may also be possible that both solvent liquids are comprised of organic solvents only. For example, the feed stream may comprise ethanol as the first solvent liquid and the desorbing liquid may comprise hexane as the second solvent liquid. In the present application, the term “set consisting of at least one essentially pure solvent compound” was introduced to indicate that, apart from possible other factors, it is the difference in the capability of the two sets of solvent liquids to remove an adsorbed compound from the sorbent material that contibutes to the separation of solute A and solute B.

In a remotely related field (SMB adsorption separation, which process aims at separating a mixture of two liquids) Chiang, A. S. T. (ref. 4) describes the use of binary desorbent systems. Such binary desorbent systems, which will contain an organic liquid, are used so as to have a better control over the desorbent strength of the desorbent second solvent liquid. It is concluded by Chiang that the strength of the desorbent liquid is not as important as has been thought.

To allow for a reduction in the cost of solvent liquids, it is preferred that after separation a stream comprising the organic solvent in a diluted form is subjected to a separation step for recovering the organic solvent in a form suitable for reusing it for separating solute A and solute B.

According to a further preferred embodiment the desorbing liquid and the first liquid have at least one solvent compound in common.

This makes it easier to regenerate solvent liquids as less effort is needed to sufficiently purify the solvent liquid. For example, when used with water as the other solvent liquid it is more economical to use aqueous ethanol as a desorbent liquid instead of essentially pure methanol, even if both liquids are equally effective in separating A and B. Regenerating essentially pure methanol from diluted methanol (for example from the raffinate stream), is much more costly than working up a diluted aqueous ethanol solution to a less aqueous ethanol solution.

The present invention is very suitable for feed streams comprising the compounds to be separated derived from a fermentation process, such as derived from a fermentation process and comprising an antibiotic, for example a polyketide antibiotic, as solute A.

The present invention will now be illustrated by way of example only and with reference to the drawing in which

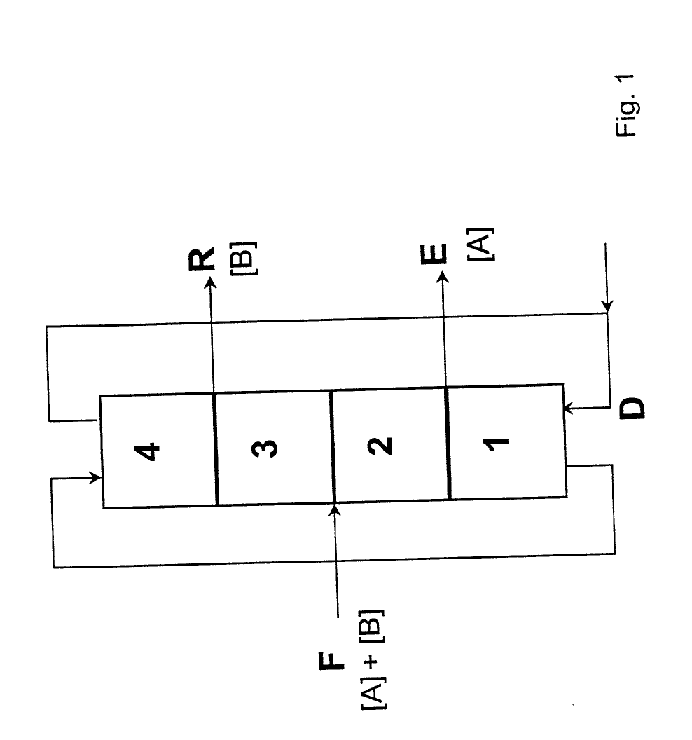

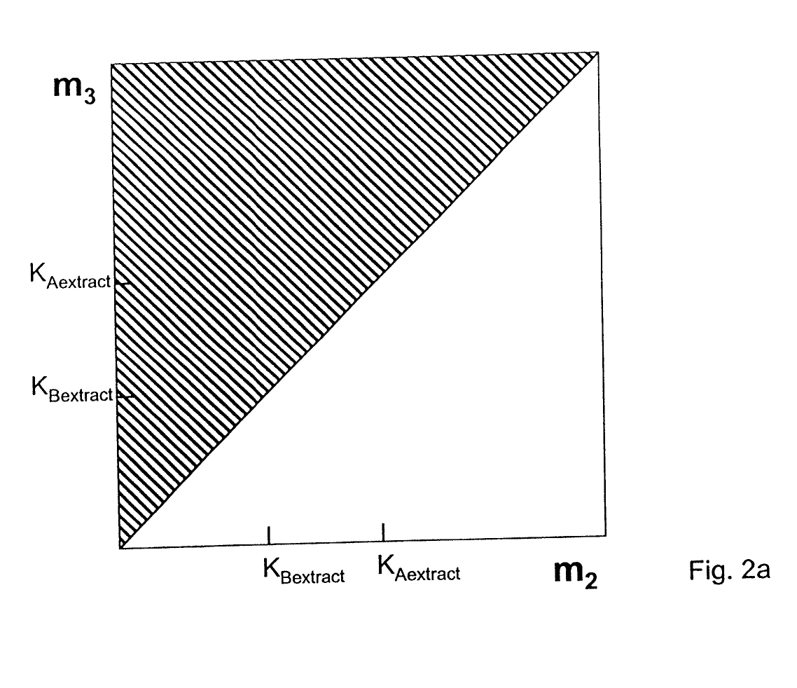

FIG. 1 schematically shows a Simulated Moving Bed apparatus; and

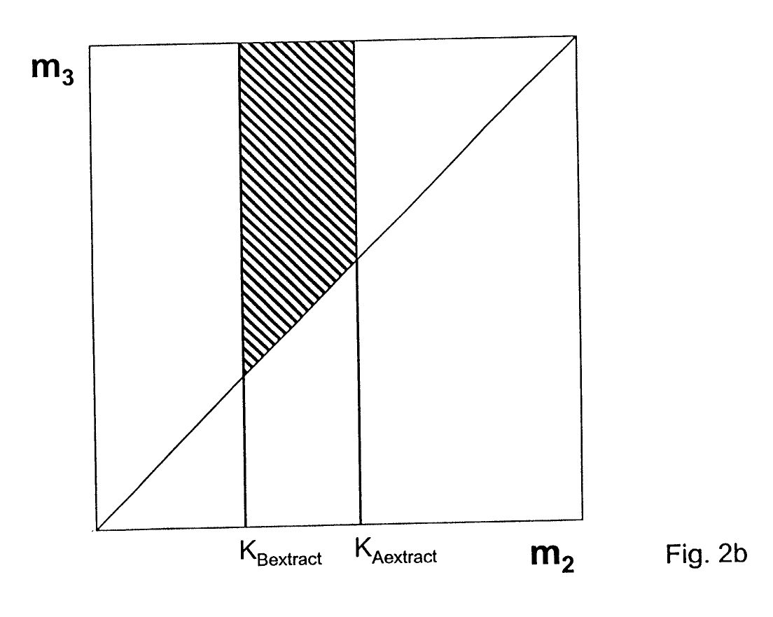

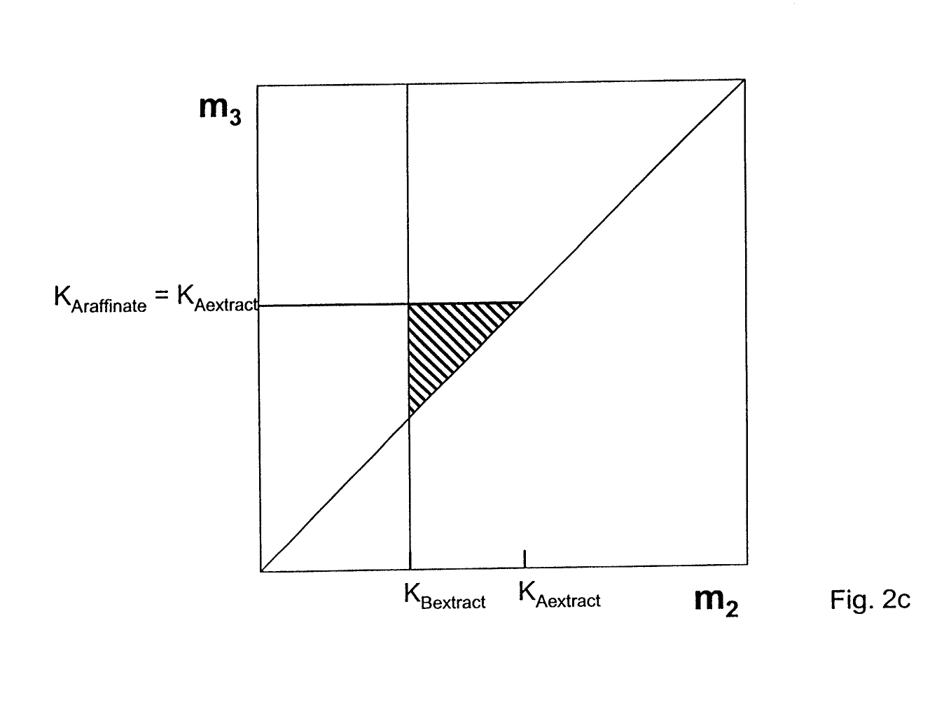

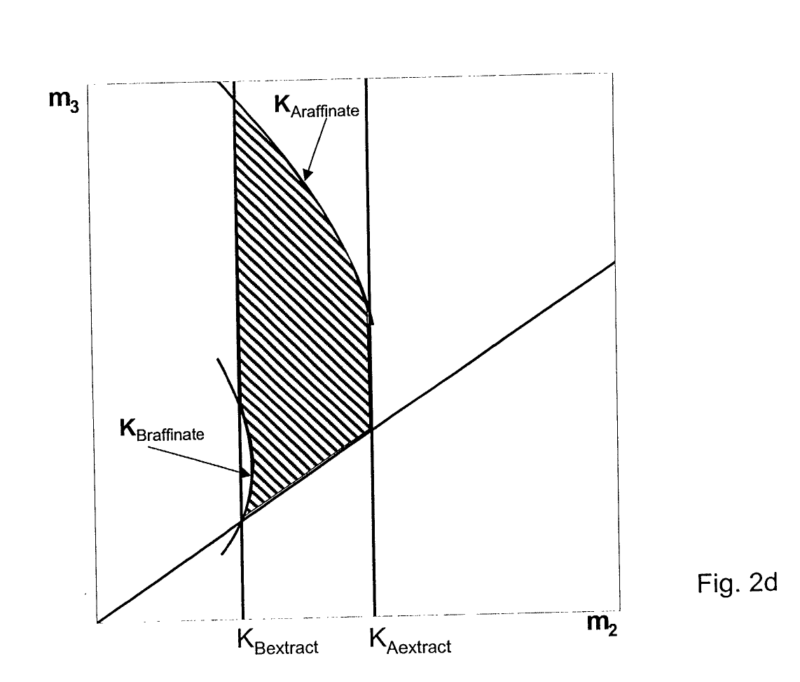

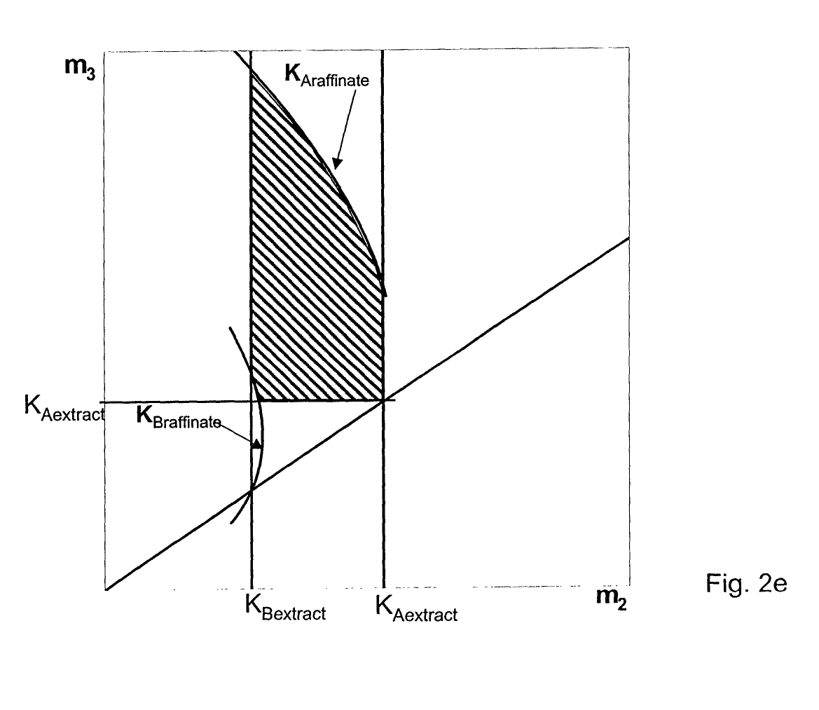

FIG. 2 a-e show graphs indicating for which values of m2 and m3 a concentrated solute A can be obtained.

### EXAMPLE

Operating a Simulated Moving Bed apparatus is widely known in the field. Basically an SMB apparatus comprises four sections, as shown in FIG. 1, all of which contain a sorbent, which sorbent is selected in connection with a desorbent liquid for its capability to show different adsorption characteristics for a compound A and a compound B to be separated. This behaviour as to the adsorption characteristics is described by a partition coefficient K. It goes without saying that the ratio between K_{A} and K_{B} should be as large as possible. This is because it allows for a better separation with a particular SMB apparatus, or an equivalent good separation with a smaller (and thus cheaper) SMB apparatus. Determination of (chromatographical) partition coefficients is well known in the art (ref. 1).

A feed stream F comprising the compounds A and B is introduced into the SMB apparatus between sections 2 and 3. A desorbent stream D is introduced into section 1. An extract stream E comprising compound A is discharged between section 1 and 2, and a raffinate stream R comprising compound B is discharged between section 3 and 4. The ratio between i) the apparent liquid flow rate in a section; and ii) the sorbent flow rate in that section is indicated as m. The (apparent) sorbent flow rate is determined by the frequency at which valves controlling the SMB process are switched and the sections change function (that is, section 1 becomes section 4, section 4 becomes section 1 etc.).

If K/m is smaller than 1, the compound for which the K value applies moves upstream with respect to the liquid flow in the SMB.

As a more detailed description of an SMB apparatus and the SMB process is not necessary for the illustration of the present invention, the interested reader is referred to one of the text books on SMB.

For concentration of compound A to occur, it does not suffice if the flow rate of the extract stream E is smaller than the flow rate of the feedstream F. Here it is illustrated how the specific conditions under which concentration is possible may be determined.

1. The solvent compositions of the Raffinate stream R and the extract stream E are chosen depending on the desired extent of separation. The solvent composition of the raffinate stream R is a mixture of both the first solvent liquid of the feed stream F and the second solvent liquid of the desorbent stream D. The solvent composition of the extract stream E is essentially the same as composition of the second solvent liquid.

Instead, it is also possible to estimate the K values for the solutes A and B by calculating them using the formula:

log K_{C}=φ log K_{C1}+(1−φ) log K_{C2}

wherein C represents A or B. 1 denotes the first solvent and 2 the second solvent; and φ is the volume fraction of the first solvent in the raffinate stream R.

2. The values of m2 and m3 are chosen such that

i) m2<m3

ii) K_{Bextract}<m2,

iii) m3<K_{Araffinate}

as is customary in the art. For a given flow rate of the feed stream F, and using the chosen for values of m2 and m3, it is possible to calculate the flow rates of the desorbent stream D and the outgoing streams R and E.

3. Now, according to the present invention, from the range of values for m2 and m3, those are chosen for which iv) m2<K_{Aextract}; and v) m3>K_{Braffinate}, As the K value depends on the value of m3 (the K value depends on the volume fraction φ), although this upper and lower curves can be found algebraically, they can also be easily computed numerically (using a numerical solver of the Newton-Raphson type, as is described in text books on calculus or numerical analysis).

It is thought to be illuminating to stepwise display all the limitations graphically.

FIG. 2a shows which values of m2 and m3 satisfy the condition that m2<m3. If this condition were not met, no feed stream would enter the SMB apparatus.

FIG. 2b depicts in addition the conditions of ii) and iv) K_{Aextract}<m2<K_{Aextract}. If these conditions were not met, solute B would end up in the extract stream, thus making the purity of A poor.

FIG. 2c depicts in addition the condition iii) of m3<K_{Araffinate} (According to the state of the art, K_{Araffinate}=K_{Aextract}) . If this condition were not met, solute A would end up in the raffinate stream, thus making the purity of B poor.

FIG. 2d depicts the condition of iii) where m3<K_{Araffinate} for the present invention.

FIG. 2e depicts in addition the condition according to the present invention that m3>K_{Braffinate} and m3>K_{Aextract*}It is only within this specific range (hatched) that concentration of solute A in the extract stream E is achieved.

For binary solvent systems the formulas for K_{Araffinate} and K_{Braffinate} are respectively

Analytical equations for the two curved lines, K_{Araffinate} and K_{Braffinate} (functions of m3. See FIG. 2d and 2e):

$${K}_{Araffinate} = \frac{m3 \cdot log ( m3 ) - m3 \cdot ( {φ}_{F} - log ( {K}_{A1} ) + ( 1 - {φ}_{F} ) \cdot log ( {K}_{A1} ) )}{( {φ}_{D} - {φ}_{F} ) \cdot log ( {K}_{A2} ) + ( {φ}_{F} - {φ}_{D} ) \cdot log ( {K}_{A1} )}$$

$${K}_{Braffinate} = \frac{m3 \cdot log ( m3 ) - m3 \cdot ( {φ}_{F} - log ( {K}_{B2} ) + ( 1 - {φ}_{F} ) \cdot log ( {K}_{B1} ) )}{( {φ}_{D} - {φ}_{F} ) \cdot log ( {K}_{B2} ) + ( {φ}_{F} - {φ}_{D} ) \cdot log ( {K}_{B1} )}$$

wherein

m2 is the ratio of a) the liquid flow rate in zone 2; and b) the sorbent flow rate in zone 2;

m3 is the ratio of a) the liquid flow rate in zone 3; and b) the sorbent flow rate in zone 3;

φ_{F} volume fraction of one of the solvents of the binary solvent mixture in the feed stream;

φ_{D} volume fraction of the same solvent of the binary solvent mixture in the desorbent stream;

K_{A1} is the (chromatographical) partition coefficient of solute A in the first (pure) solvent liquid

K_{A2} is the partition coefficient of solute A in the second solvent liquid

K_{B1} is the partition coefficient of solute B in the first solvent liquid

K_{B2} is the partition coefficient of solute B in the second solvent liquid

1. Method of substantially continuously separating a first solute A and a second solute B which are present in a feed stream further comprising a first solvent liquid, using a moving-bed device which contains a sorbent material and comprises an inlet for the feedstream, an inlet for a desorbing second solvent liquid, an outlet for an extract stream comprising solute A, an outlet for a raffinate stream comprising solute B, and a further outlet, said method comprising
introducing the feed stream into the moving-bed device;
introducing the desorbing second solvent liquid into the moving-bed device in a relative countercurrent motion with respect to the sorbent material;
discharging the extract stream relatively enriched in solute A with respect to solute B; and
discharging the raffinate stream relatively enriched in solute B with respect to solute A;
the course between the inlet for second solvent liquid and the outlet for the extract stream defining a first zone 1;
the course between the outlet for the extract stream and the feed stream inlet defining a second zone 2;
the course between the feed stream inlet and the outlet for the raffinate stream defining a third zone 3; and
the course between the outlet for the raffinate stream and the further outlet defining a fourth zone 4;
wherein in each of the zones k, k being 1-4, mₖ, is defined as the ratio of a) the liquid flow in zone k; and b) the sorbent flow in zone k,
wherein a solvent liquid comprises an organic solvent, the first solvent liquid and the desorbing second solvent liquid being completely miscible with each other; and
K_{Aextract} is defined as the partition coefficient of solute A in the solvent liquid of the extract stream;
K_{Bextract} is defined as the partition coefficient of solute B in the solvent liquid of the extract stream;
K_{Araffinate} is defined as the partition coefficient of solute A in the solvent liquid of the raffinate stream;
K_{Braffinate} is defined as the partition coefficient of solute B in the solvent liquid of the raffinate stream,
and m2 and m3 are chosen such that
i) m2<m3
ii) K_{Bextract}<m2,
iii) m3<K_{Araffinate}
wherein at least one of i) the desorbing second solvent liquid; and ii) the first solvent liquid comprises an organic solvent, each solvent liquid comprising a set consisting of at least one essentially pure solvent compound, whereby the sets of the solvent liquids are selected to differ in their capability to remove an adsorbed compound from the sorbent material, and
iv) m2<K_{Aextract} and m2 and m3 are chosen such that for a particular m2
v) m3>K_{Braffinate} and m3>K_{Aextract}.

2. Method according to claim 1, wherein after separation a stream comprising the organic solvent in a diluted form is subjected to a separation step for recovering the organic solvent in a form suitable for reusing the organic solvent for separating solute A and solute B.

3. Method according to claim 1, wherein the desorbing liquid and the first liquid have at least one solvent compound in common.

4. Method according to claim 1, wherein the feed stream comprising the compounds to be separated is derived from a fermentation process.

5. Method according to claim 4, wherein the feed stream derived from a fermentation process comprises an antibiotic as solute A.

6. Method according to claim 5, wherein the antibiotic is a polyketide antibiotic.
